(19) United States
(12) Patent Application Publication
(10) Pub. No.: US 2006/0080892 A1
(43) Pub. Date: Apr. 20, 2006

(54) Device for driving the movement of a swing gate with relative position control

(75) Inventor: Ennio Di Saverio, Teramo (IT)

Correspondence Address: PEARNE & GORDON LLP, 1801 EAST 9TH STREET, SUITE 1200, CLEVELAND, OH, 44114-3108, US

(73) Assignee: SEA USA INC., Miami, FL (US)

(21) Appl. No.: 10/999,473

(22) Filed: Nov. 30, 2004

(30) Foreign Application Priority Data
Oct. 20, 2004 (EP) 04425791.3

(51) Int. Cl. E05F 11/24

(52) U.S. Cl. 49/341

(57) ABSTRACT

A device (1) for driving the movement of a gate (2) which swings on a fixed supporting structure (3) comprises a gate (2) driving part (4); and a sensor (5), for detecting the angle of rotation that the gate (2) describes between its open and closed end positions. The location of the sensor (5) is independent of the driving part (4) and the sensor is directly supported, and without distinction, by the gate (2), or by the relative fixed supporting structure (3). The device (1) also comprises a linkage (6) which connects the sensor (5) and the gate (2) and which, when the gate (2) is operated, correlates the travel of a sensor (5) sensitive element to the actual angle of rotation of the gate (2) relative to its fixed supporting structure (3).

### BACKGROUND OF THE INVENTION

The present invention relates to a device for driving a gate, which swings on a supporting structure.

Gate automation technology already includes automated driving devices. These in particular comprise a part for mechanised driving of the gate and a sensor designed to take the appropriate readings and supply corresponding signals to a control system which then determines the corresponding angle of rotation described by the gate during the angular travel between its fully open and closed end positions.

Document EP 0856630 describes a device of this type in which the angle of rotation of the gate is determined indirectly as a function of an angle, defined by the position assumed by the structure of the driving part relative to a fixed support, and which is read by a sensor positioned directly on a turning connection, operating between the driving part and the relative support.

Since the actuator part is normally a linear actuator which while driving the gate oscillates about the support to which the sensor is attached with a rather limited angle—even when the gate assumes the maximum angular travel which corresponds to passage from the fully open condition to the fully closed condition—definition of the instantaneous position of the gate, in this type of device, is rather imprecise and in any event strictly dependent on the resolution of the sensor.

### SUMMARY OF THE INVENTION

The main aim of the present invention is, therefore, to overcome the disadvantages linked to the indirect definition of the angular position of the gate, by directly reading the angle of rotation actually described by the gate relative to its supporting structure, and totally irrespective of both the actuator part which drives gate movement and the position of the sensor relative to said part.

Accordingly, this aim is fulfilled by a device for driving the movement of a gate, which swings about a relative fixed supporting structure, comprising a gate driving part and a sensor for detecting the angle of rotation described by the gate between its open and closed end positions, characterised in that the location of the sensor is independent of the driving part, and the sensor is supported directly, and without distinction, by the gate or by the relative supporting structure; and also comprising a linkage which connects the sensor and the gate and which, when the gate is operated, correlates the travel of a sensor sensitive element to the actual angle of rotation of the gate relative to its supporting structure.

Another aim of the invention is to be able to freely increase the precision of the definition of the angular position of the gate by suitably amplifying the reading of the angle of rotation of the gate.

Such a result is achieved by sizing the rods of the linkage in such a way as to provide a scale factor suited to the precision required to define the angular position of the gate.

Obviously, without compromising safety for people, which is another essential aim of the invention, the rods of the linkage are sized and fixed in such a way that they are constantly out of alignment with one another—whatever the angular travel of the gate—so as to prevent the linkage from generating conditions which might allow crushing.

The same result may also be achieved in an equivalent way with an alternative embodiment in which the linkage comprises rods which extend in a curved line.

Further technical features of the present invention, in accordance with the aforesaid aims, are clearly illustrated in the claims herein, and the advantages of the invention are more clearly shown in the detailed description below, with reference to the accompanying drawings.

### BRIEF DESCRIPTION OF THE DRAWINGS

In the accompanying drawings, which illustrate a preferred embodiment of the invention without limiting its scope of application:

FIG. 1 is a perspective assembly view of a gate equipped with the driving device made according to the present invention;

FIG. 2 is an enlarged and more detailed perspective view of the device illustrated in FIG. 1;

FIG. 3 is a perspective and partial assembly view of an alternative embodiment of the driving device made according to the invention.

### DESCRIPTION OF THE PREFERRED EMBODIMENTS

With reference to FIG. 1 in the accompanying drawings, the numeral 1 denotes as a whole a device for driving the movement of a gate 2 mounted in such a way that it swings on a relative fixed supporting structure 3.

The device 1 basically comprises: a part 4 for driving the gate 2, preferably consisting of a linear actuator; a sensor 5, for detecting the angle of rotation that the gate 2 describes between its open and closed end positions; and a linkage 6 which operatively connects the sensor 5 and the gate 2.

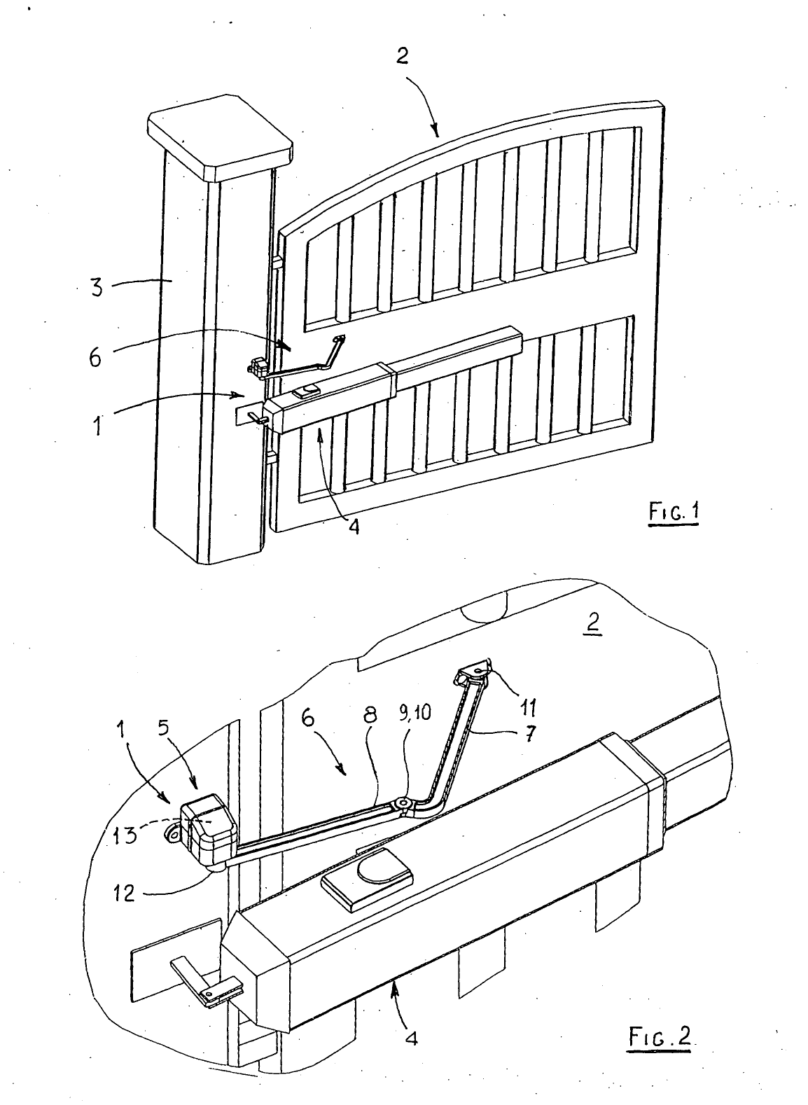

As is clearly illustrated in FIG. 2, the location of the sensor 5 is independent of the driving part 4. It is also directly supported by the gate 2 fixed supporting structure 3, even if, as is more clearly described below, it could without distinction be supported by the gate 2 which is mobile relative to the fixed structure 3.

The linkage 6, which connects the sensor 5 and the gate 2, comprises two rods 7 and 8, which have first ends 9 and 10 hinged to one another and second ends 11 and 12 hinged, in turn, one to the gate 2 or to the relative fixed supporting structure 3, and the other to the sensitive element of the sensor 5.

Thanks to the freedom allowed by the hinge connections, driving the gate 2 causes the linkage 6 to drive the movement of the sensitive element of the sensor 5, correlating the movement of the latter with the actual angle of rotation of the gate 2 relative to its fixed supporting structure 3.

The linkage 6 is also preferably designed with lever ratios which determine a scale factor designed to amplify the output movement on the sensitive element of the sensor 5, relative to the input movement consisting of the angular travel of the gate 2. Advantageously, this makes it possible to influence the actual resolution of the sensor 5 and, therefore, the precision of the definition of the angular position of the gate 2 by simply operating, only on the sizing of the linkage 6, all other conditions being equal. This allows: on one hand the advantage of a high level of precision in the definition of the angular position of the gate; and on the other the advantage of not having to absorb the costs of high technological quality device 1 control system sensors and components.

To avoid the occurrence, while driving the gate 2, of conditions potentially dangerous to people and animals passing close to the gate, the linkage 6 is designed in such a way that the rods 7 and 8 constantly remain out of alignment with one another, whatever the angle of rotation assumed by the gate 2 relative to its fixed supporting structure 3. This is achieved by combining a suitable choice of length of the rods 7 and 8 with a predetermined distance for the fixing points: between the linkage 6 and the gate 2; and between the sensor 5 and the fixed structure 3.

Such a result may be achieved—alternatively or in addition to what is described above—by assigning at least one of the rods 7 in the linkage a configuration which is at least partly curved, as visible in FIG. 2.

Since the device 1 is designed to directly read an angular movement, that is to say rotation of the gate 2, the most suitable sensor 5 construction comprises an angular resolver 13, or a conventional encoder, in which the sensitive element consists of a rotary disk attached to an optical reading device. Such an embodiment is an example only and does not limit the scope of the invention, since it is evident to a technician in the sector that the sensor 5 could comprise many other equivalent means, for example, an equivalent linear resolver equipped with a conventional transducer which converts the angle of rotation of the gate 2 into a corresponding movement which can be read by the resolver 13.

It should also be noticed that since the driving device 1 is fully independent of the gate 2 driving part 4, advantageously it may be used on the widest variety of constructions of gates 2, even those already built and which may already be in operation, as well as also being equipped with any driving parts 4.

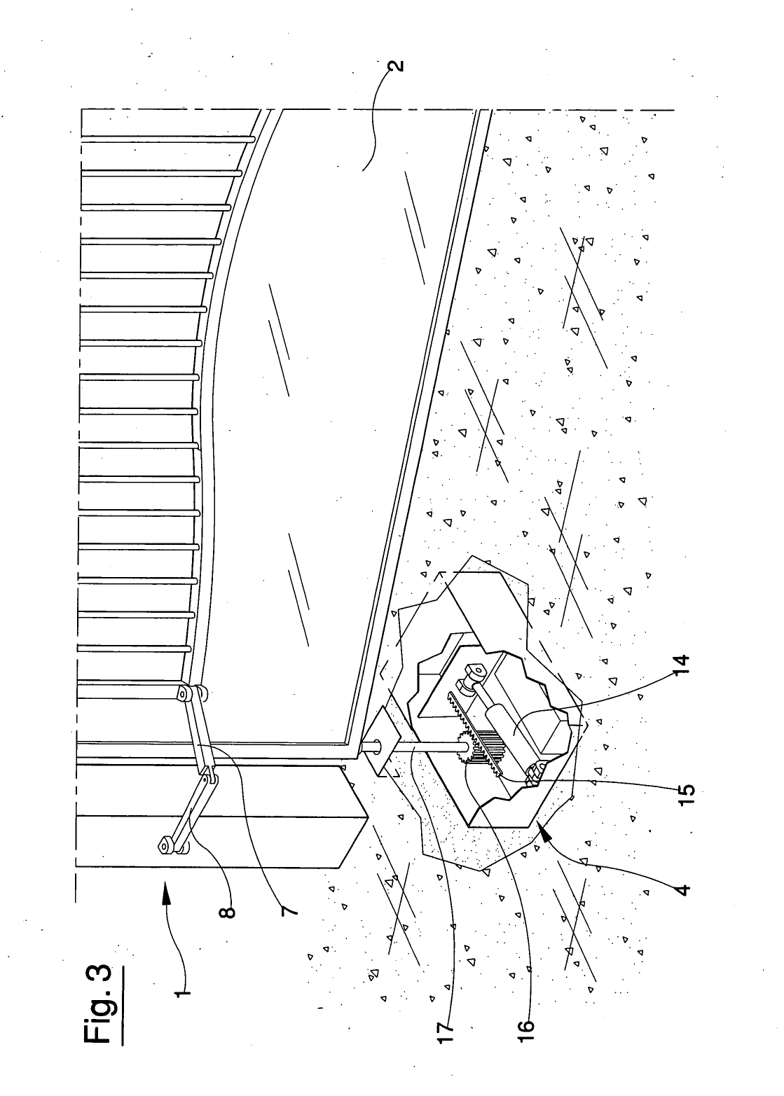

This appears quite obvious in FIG. 3, which illustrates application of the device 1 to a gate 2 driven by a buried driving part 4; the part 4 more specifically comprising a piston 14 which operates—by means of a rack 15—a sprocket 16 which in turn drives a driving pin 17 which is integral with the gate 2.

The invention described is suitable for obvious industrial applications and may be subject to modifications and variations without thereby departing from the scope of the inventive concept. Moreover, all details of the invention may be substituted by technically equivalent elements.

What is claimed:

1) A device for driving the movement of a gate (2) which swings on a relative fixed supporting structure (3), comprising a gate (2) driving part (4); and a sensor (5), for detecting the angle of rotation that the gate (2) describes between its open and closed end positions; wherein the location of the sensor (5) is independent of the driving part (4), and the sensor is directly supported, without distinction, by the gate (2) or by the fixed supporting structure (3); and also wherein it comprises a linkage (6) which connects the sensor (5) and the gate (2) and which, when the gate (2) is operated, correlates the travel of a sensor (5) sensitive element to the actual angle of rotation of the gate (2) relative to the fixed supporting structure (3).

2) The device according to claim 1, wherein the linkage (6) is designed in such a way as to correlate the angle of rotation of the gate (2) and the travel of the sensor (5) sensitive element with a scale factor selected according to the achievement of a desired sensor (5) angular resolution.

3) The device according to claim 2, wherein the linkage (6) comprises at least two rods (7, 8), having first ends (9, 10) hinged to one another and second ends (11, 12) hinged: one to the gate (2) or the relative fixed supporting structure (3); and the other to the sensor (5) sensitive element.

4) The device according to claim 2, wherein the linkage (6) is designed in such a way that the rods (7, 8) constantly remain out of alignment with one another, whatever the angle of rotation of the gate (2) relative to its fixed supporting structure (3).

5) The device according to claim 2, wherein the linkage (6) includes at least one curved rod (7).

6) The device according to claim 3, wherein the linkage (6) includes at least one curved rod (7).

7) The device according to claim 4, wherein the linkage (6) includes at least one curved rod (7).

8) The device according to any of the foregoing claims from 1 to 7, wherein the sensor (5) comprises an angular resolver (13) with a sensitive element in the shape of a rotary disk.

9) The device according to any of the foregoing claims from 1 to 7, wherein the sensor (5) comprises a linear resolver equipped with a transducer for the angle of rotation of the gate (2).

10) The device according to claim 1, wherein the driving part (4) acts on a rotary pin (17) which is integral with the gate (2).
